(19) United States
(12) Patent Application Publication
(10) Pub. No.: US 2017/0225802 A1
(43) Pub. Date: Aug. 10, 2017

(54) SYSTEMS AND METHODS FOR DEPLOYMENT AND OPERATION OF VERTICAL TAKE-OFF AND LANDING (VTOL) UNMANNED AERIAL VEHICLES

(71) Applicant: Systems Engineering Associates Corporation, Middletown, RI (US)

(72) Inventors: David A. Lussier, Exeter, RI (US); Andrew Delisle, Tiverton, RI (US); Brian Charpentier, Coventry, RI (US)

(73) Assignee: Systems Engineering Associates Corporation, Middletown, RI (US)

(21) Appl. No.: 15/518,966

(22) PCT Filed: Oct. 13, 2015
(86) PCT No.: PCT/IB15/57837

§ 371 Date: Apr. 13, 2017

Related U.S. Application Data
(60) Provisional application No. 62/063,285, filed on Oct. 13, 2014.

(51) Int. Cl. B64F 1/22; B60L 11/18; E04H 12/18; B63B 35/50; G01S 19/03; E04H 12/00; B64C 39/02; B64D 47/08

(52) U.S. Cl. CPC B64F 1/222; B64C 39/024; B60L 11/1833; B64D 47/08; B63B 35/50; G01S 19/03; E04H 12/003; E04H 12/18; B64C 2201/024; B64C 2201/021; B64C 2201/042; B64C 2201/08; B64C 2201/127; B64C 2201/201; B64C 2201/146

(57) ABSTRACT

An unmanned aerial vehicle (UAV) system provides for UAV deployment and remote, unattended operation with reduced logistics requirements. The system includes a launcher that can include one or more containers, or hangars, configured to house vertical take-off and landing (VTOL) UAVs. The system can further include a VTOL UAV orientation and charging module configured to mechanically position a UAV within a container and facilitate electrical mating and charging of a battery in the UAV. These operations, and others, can be performed by remote command that can initiate a series of pre-programmed steps. The UAV system can further include a power generation and storage subsystem, a security subsystem, a command and control subsystem and a communications subsystem. Command, control and communications can be provided between a remote station and the UAV.

### CROSS-REFERENCE TO RELATED APPLICATIONS

This application claims priority from U.S. Provisional Patent Application Ser. No. 62/063,285, filed Oct. 13, 2014, the disclosure of which is hereby incorporated by reference in its entirety.

### STATEMENT REGARDING FEDERALLY SPONSORED RESEARCH OR DEVELOPMENT

Not Applicable.

### BACKGROUND

Field

The disclosed subject matter is generally directed to unmanned aerial vehicle (UAV) systems, and more particularly, to systems and methods that provide for the deployment and remote operation of vertical take-off and landing (VTOL) and hybrid UAVs in, for example, reconnaissance operations.

Description of Related Art

Known UAVs can be defined as powered aerial vehicles that do not carry a human operator, use aerodynamic forces to provide vehicle lift, can fly autonomously or be piloted remotely, can be expendable or recoverable, and can carry a lethal or nonlethal payload.

There can be a wide variety of UAV shapes, sizes, configurations, and characteristics. For example, using known communications systems, UAVs can be controlled from a remote location, or fly autonomously based on pre-programmed flight plans using more complex dynamic automation systems, or a combination of both. Historically, UAVs were simple drones (remotely piloted aircraft), but autonomous control is increasingly being employed in UAVs. Known UAVs are also able to transmit data, such as video, to remote locations.

Known UAVs can perform military reconnaissance as well as strike missions. UAVs can also be used for civil applications, such as nonmilitary security work, e. g., surveillance of pipelines.

Known miniature and micro UAV systems can use fixed wing UAVs or rotary-wing UAVs that can require extensive human interaction to prepare a UAV for launch, get the UAV airborne and fly the UAV, either locally or remotely, out to radio frequency (RF) line-of-sight ranges. The UAVs generally return to the same location for landing from which they were launched so that the human operators can recover the UAVs and repair and/or prepare them for another flight.

Typical launch methods for fixed-wing UAVs can include human-powered launch by hand, or on a rail system typically powered by pneumatic, pyrotechnic, elastomeric (“bungee cord”), or electromagnetic subsystems. Both basic methods of launch require operator interaction to prepare the launcher as well as the UAV, with pre-flight checks, for example.

Additionally, known UAV deployment and operation systems, such as disclosed in U.S. Pat. No. 7,089,843 to Miller et al., can require extensive logistics. For example, air compressors, compressed air storage tanks and electrical power generators and the fuel to run them may have to be transported long distances to support the remote deployment and operation of UAVs. In some locations, the personnel and logistics requirements may make desired UAV operations impractical.

### SUMMARY

The disclosed subject matter provides a UAV deployment and operation system capable of reliable remote, unattended operation. In an embodiment, a standalone tower or trailer can support UAV storage, deployment and recovery equipment.

UAVs employed by the systems described herein may be of a rotary wing design, i.e., the UAV's are powered into flight via a rotary wing that lifts it vertically, such as in a quadcopter. As used herein as a nonlimiting example, a quadcopter, also called a quadrotor helicopter or quadrotor, can be a multirotor helicopter that is lifted and propelled by four rotors. Quadcopters are classified as rotorcraft, as opposed to fixed-wing aircraft, because their lift is generated by a set of rotors (vertically-oriented propellers). Unlike most helicopters, quadcopters can use two sets of identical fixed-pitched propellers; two clockwise (CW) and two counter-clockwise (CCW). These use variation of RPM to control lift and torque. Control of vehicle motion is achieved by altering the rotation rate of one or more rotor discs, thereby changing its torque load and thrust/lift characteristics. Hybrid VTOL UAVs can also be used. Hybrid UAVs can operate by using vertical take-off and landing and can also fly in a fixed-wing mode.

Once airborne, data from the UAV, including, for example, streaming video and telemetry data from the objects in view of the UAV's camera or other sensors, can be monitored remotely using a variety of known communications links. Remote UAV command and control can also be accomplished over a variety of communications links.

In an embodiment, UAV storage can be accomplished by stowage of UAVs in a container, such as a box “hangar” that can be electromechanically positioned within the trailer/system such that the roof above the hangar opens electromechanically allowing the UAV to take off and land back in the hangar in a generally vertical direction.

Through dual employment of UAVs that can be impulsed using an inflator-based compressed carriage system and quadcopters, for example, this technology can be adapted to a variety of UAV platforms. A mixture of compressed carriage tube-launched UAVs (as disclosed in commonly owned U.S. Pat. No. 8,439,301, the disclosure of which is incorporated herein in its entirety) can be mixed with vertical take-off and landing (VTOL) type UAVs from the same launcher platform/trailer. The technology can provide a UAV launcher that is very modular, requires little or no maintenance and can be nearly 100% operationally ready at all times. Because of the versatility of the inflators, various UAV types, with different characteristics, can be accommodated within a single launcher. Because the system is mostly self-contained, it can be used aboard most any platform, such as ground vehicles or waterborne, e.g., sea-going vessels and can be installed, removed or modified quickly for mission-specific payloads.

In an embodiment, the system can include an integrated UAV arresting gear or net to facilitate recovery of, e.g., non-VTOL UAVs. In an embodiment, the system can use solar, wind, or portable generator power to generate electricity to eliminate the need for an external power supply.

In an embodiment, access to the launcher area can be secured to prevent tampering of the unattended system, e.g., the launchers and UAVs. Components of the system can be constructed of steel or other suitable material to prevent damage from small arms fire, for example. Additionally, the system can include local security monitoring features as part of a security subsystem. For example, the tower area can have motion sensors and a camera system suitable for daytime and nighttime monitoring of the area around the UAV system. In an embodiment, when a motion sensor is triggered by a possible intruder, the camera system can be automatically activated and can be controlled from a remote station such that live streaming video of the area around the UAV system can be viewed from a remote location.

In an embodiment, an unmanned aerial vehicle (UAV) system can include a launcher, comprising one or more deployment hangars, each hangar configured to house a VTOL UAV, each hangar comprising an orientation and charging module configured to mechanically align the VTOL UAV within the hangar and facilitate electrical mating and charging of the main UAV flight battery; and a power generation and storage system comprising at least one of a photovoltaic cell or a portable generator or a wind turbine for supplying power to the UAV system.

### BRIEF DESCRIPTION OF THE DRAWINGS

As will be realized, different embodiments are possible, and the details disclosed herein are capable of modification in various respects, all without departing from the scope of the claims. Accordingly, the drawings and descriptions are to be regarded as illustrative in nature and not as restrictive. Like reference numerals or characters are used throughout the several views and embodiments to designate like components.

FIGS. 1A-1D show various views of an exemplary embodiment of a tower-mounted UAV system.

FIG. 2A shows a perspective view of an exemplary embodiment of a trailer-based portable UAV system.

FIG. 2B shows a perspective view of an embodiment of a trailer-based portable UAV system illustrating cut-away views of some interior components.

FIG. 2C shows a perspective view of an exemplary system illustrating various system components with labels.

FIG. 2D shows a perspective view of an exemplary system illustrating an alternative basic arrangement of the VTOL UAV Hangars.

FIG. 2E shows a side view of an exemplary system illustrating various components with labels.

FIG. 2F shows details of an exemplary VTOL UAV Hangar Platform with some features illustrated and labeled.

FIG. 3 shows an exemplary embodiment of a notional VTOL UAV with characteristics of a camera and charging receptacle.

FIGS. 4A-4I show exemplary embodiments of alternative configurations for a UAV system trailer.

FIGS. 5A-5G show exemplary embodiments of the UAV system alone or with a compressed-carriage impulse launch system along with command and control features.

### DETAILED DESCRIPTION

To facilitate an understanding of the principles upon which the subject matter disclosed herein is based, most illustrative embodiments are described hereinafter with reference to their implementation at a remote, land-based site. It will be appreciated that the practical applications of these principles are not limited to this particular type of implementation. Rather, they can be equally employed in any other type of UAV system operating environment where it is desired to provide for periods of deployment and operation with reduced personnel and logistics requirements.

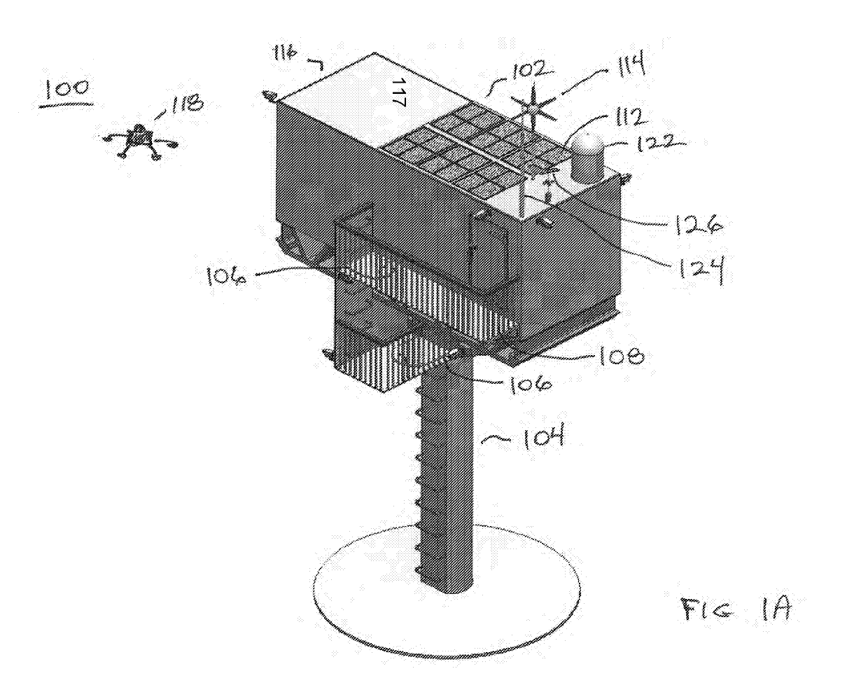

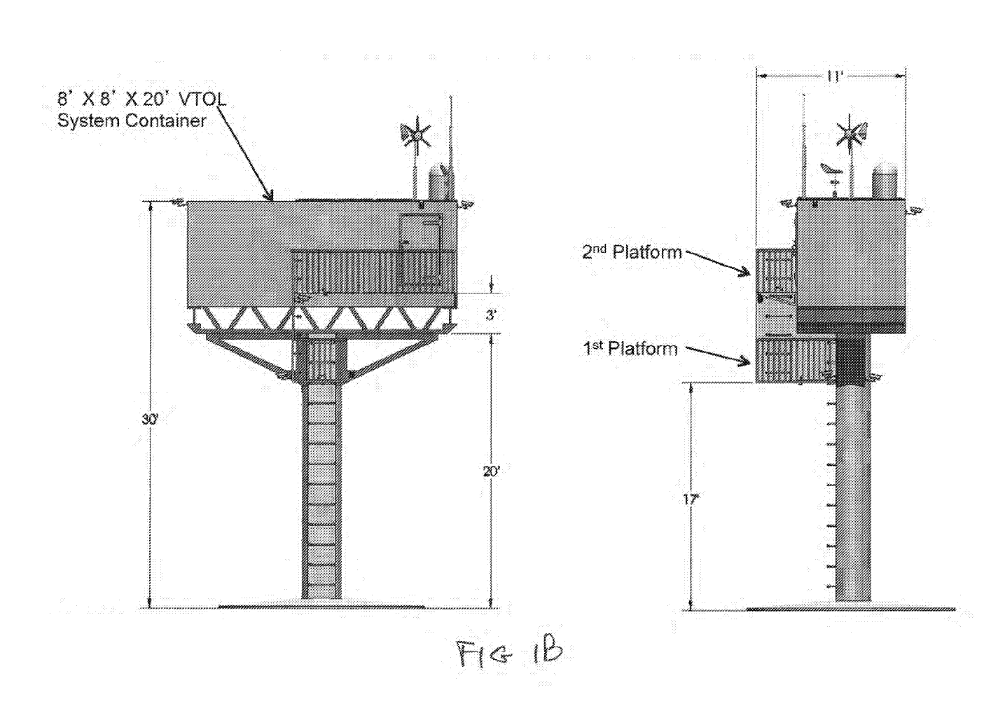

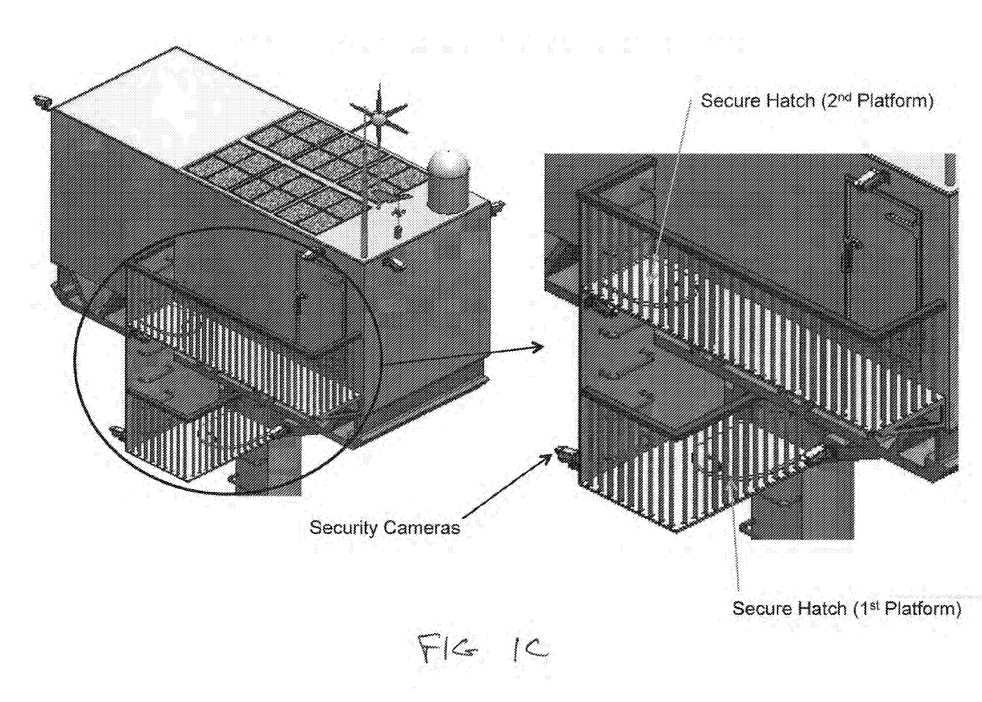

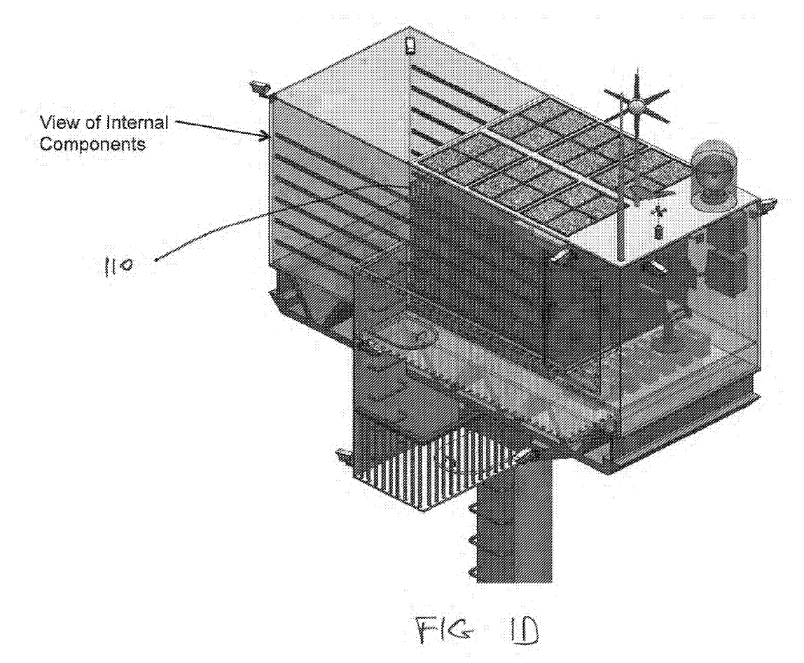

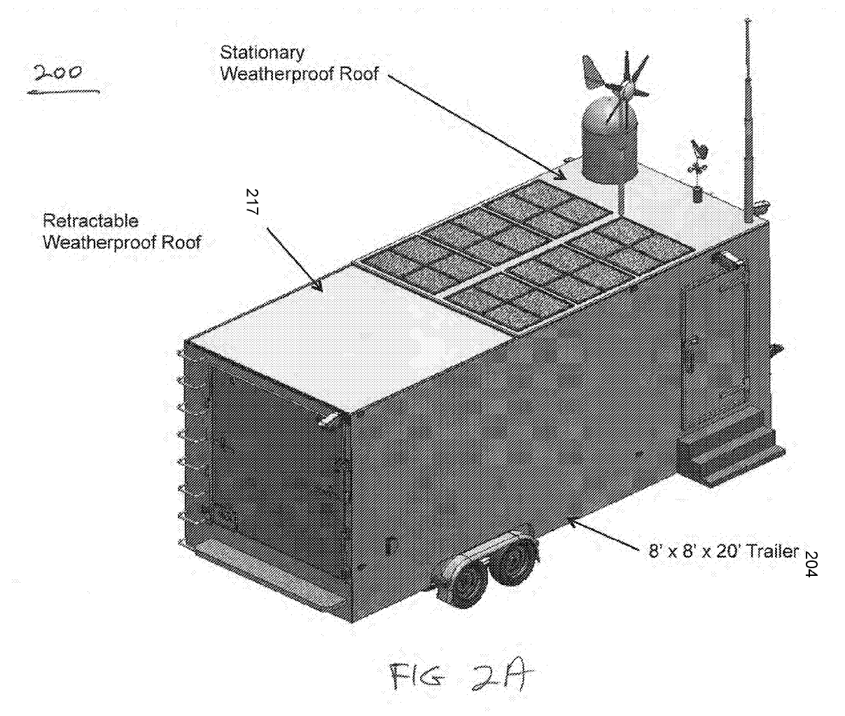

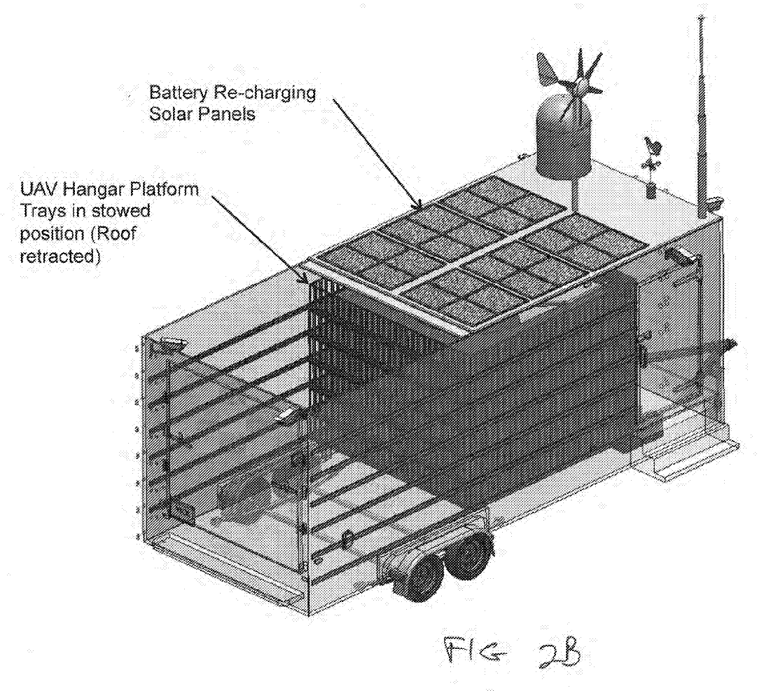

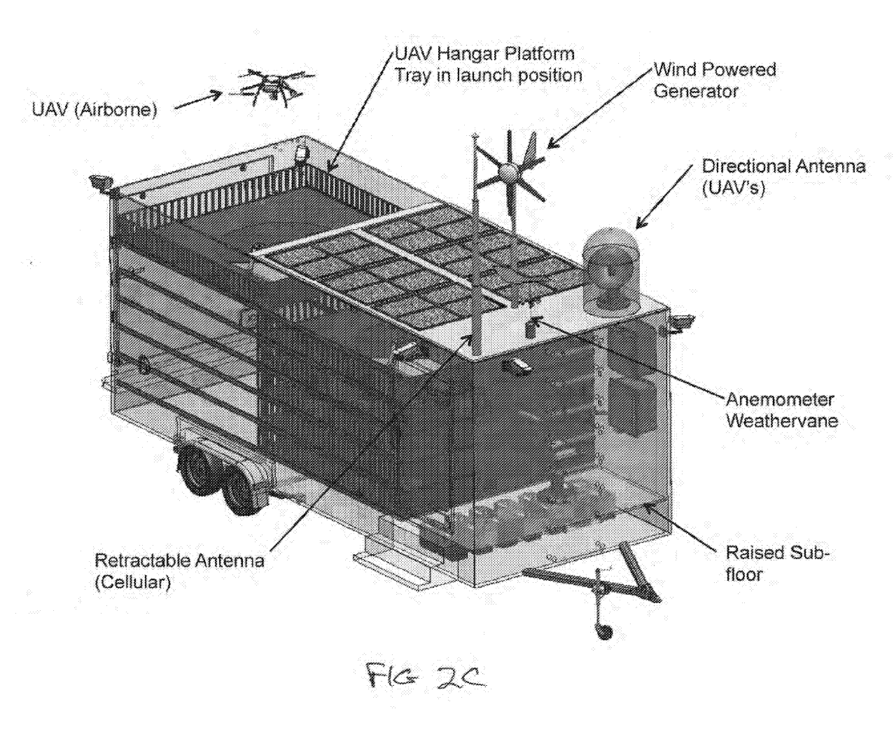

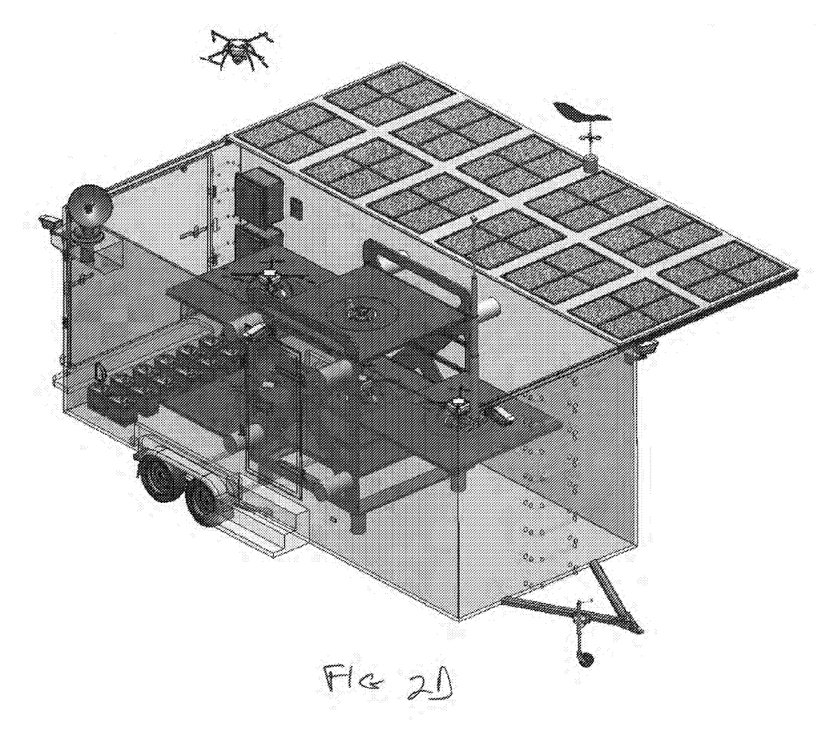

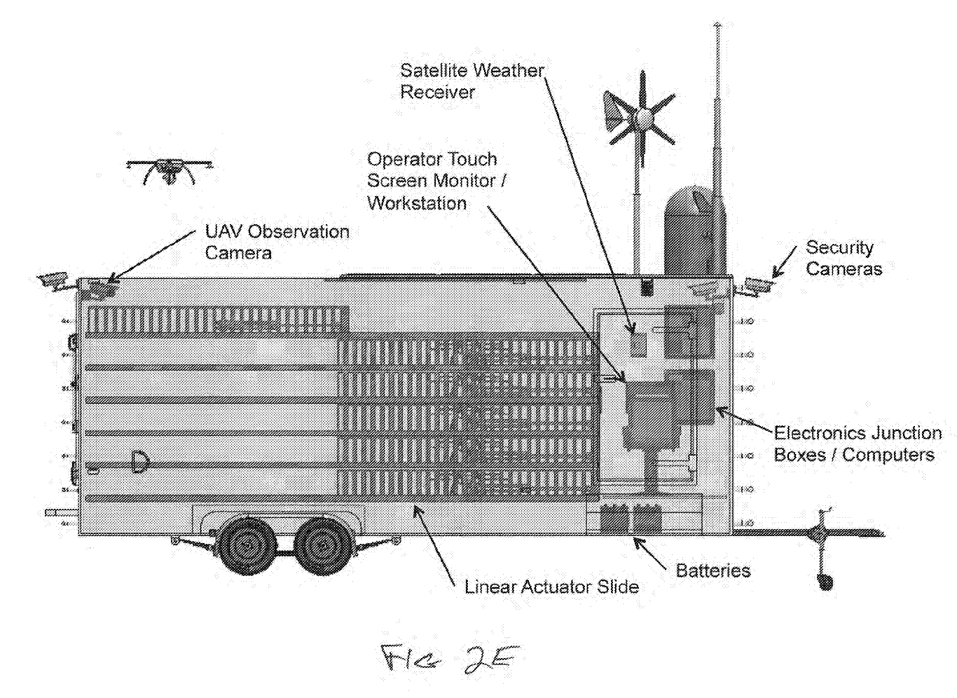

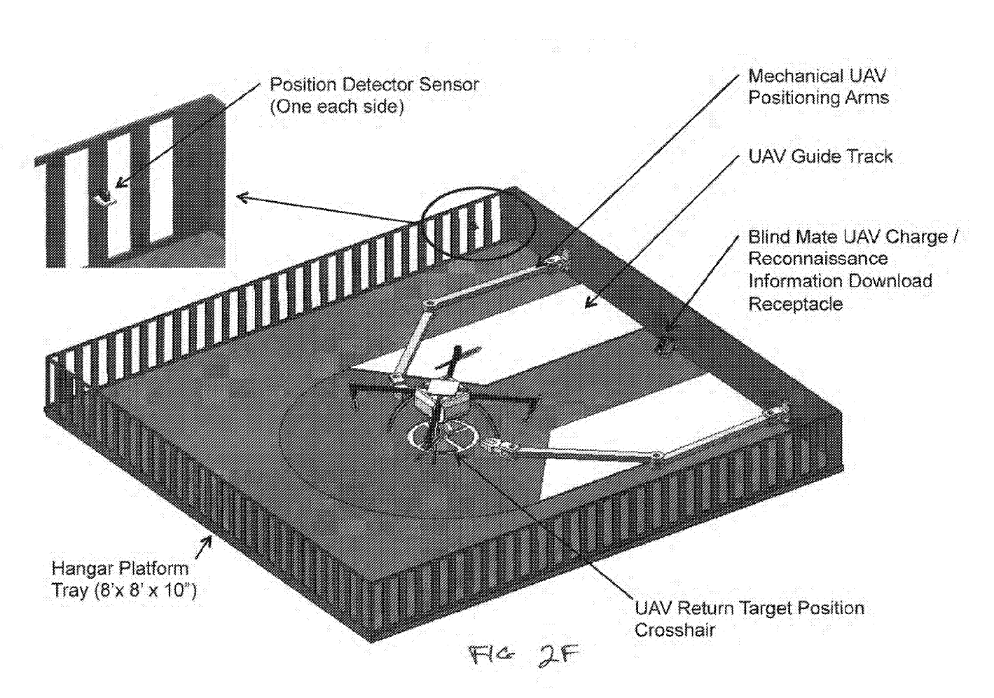

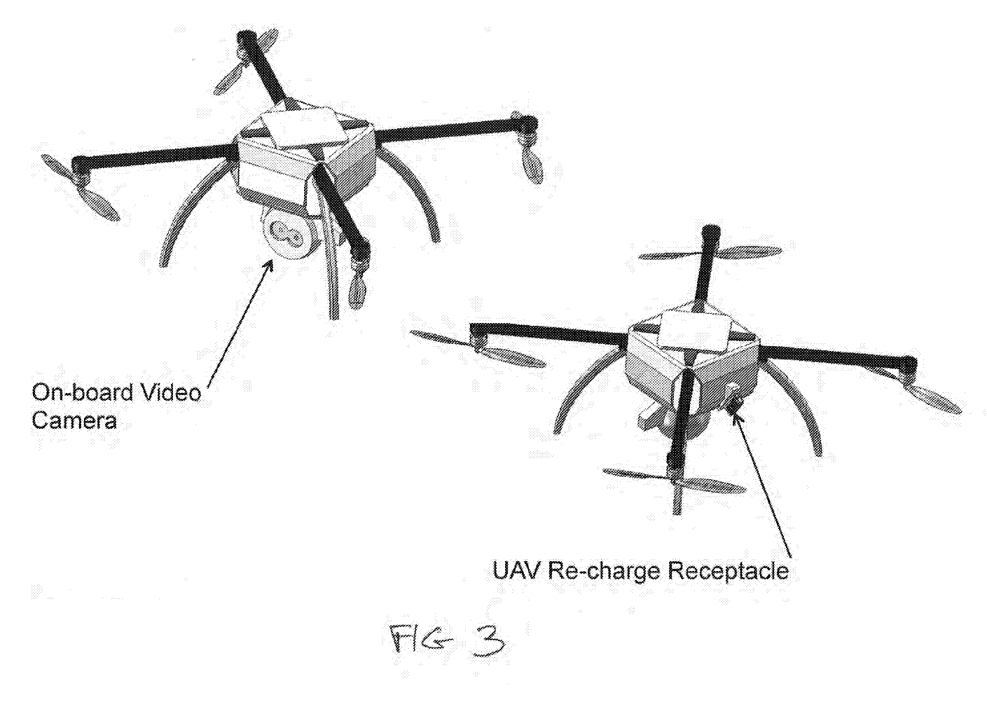

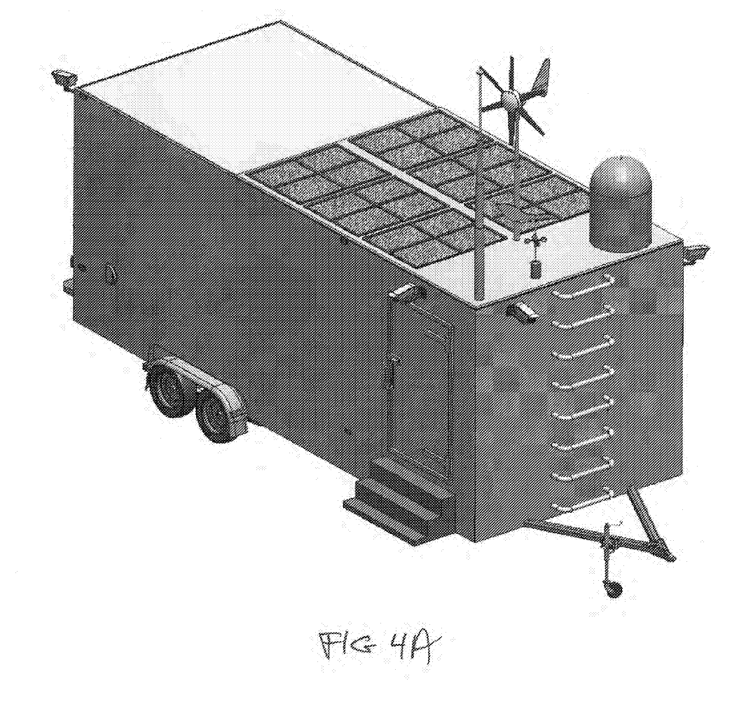

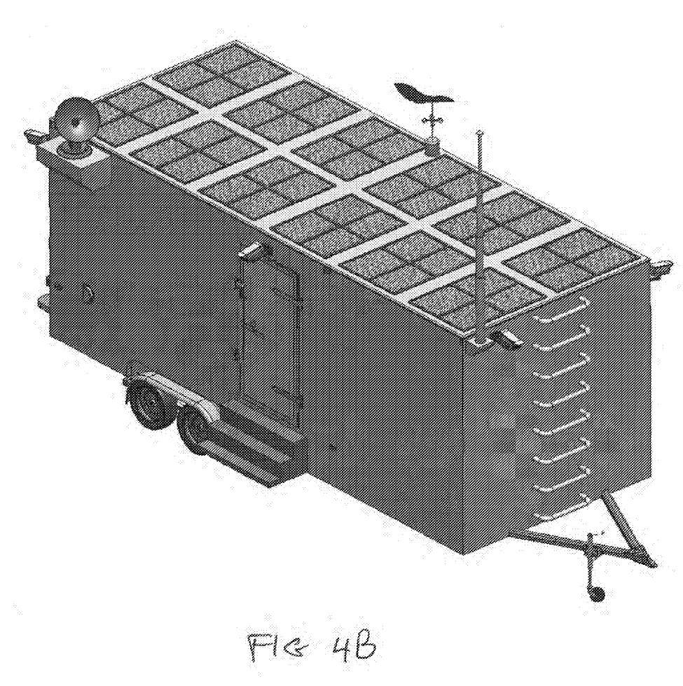

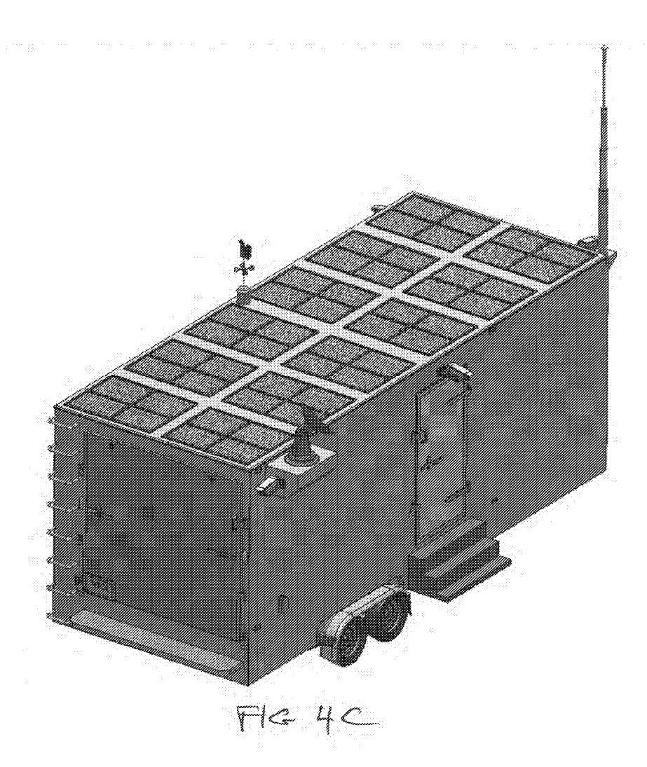

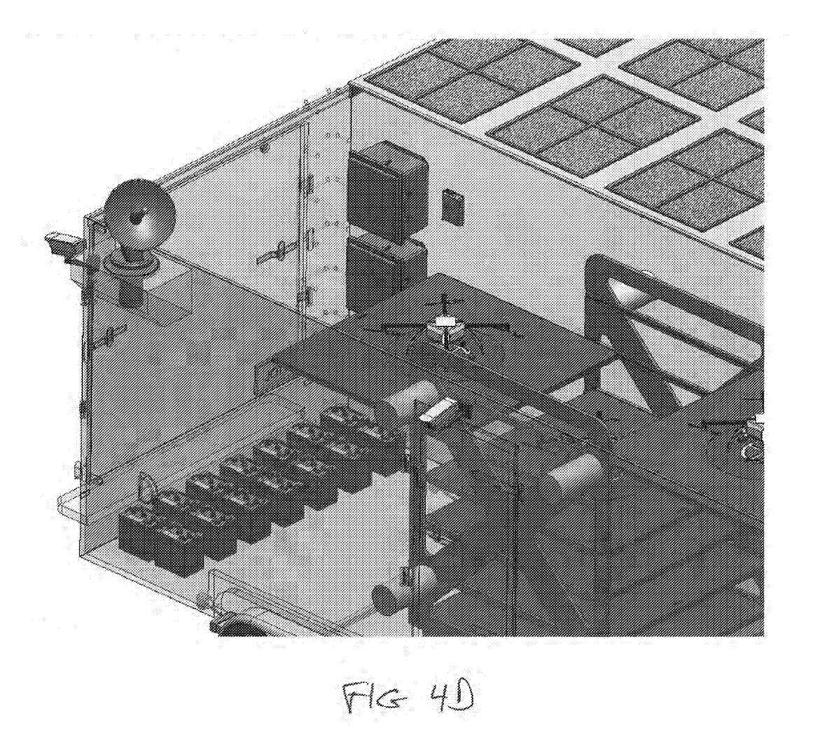

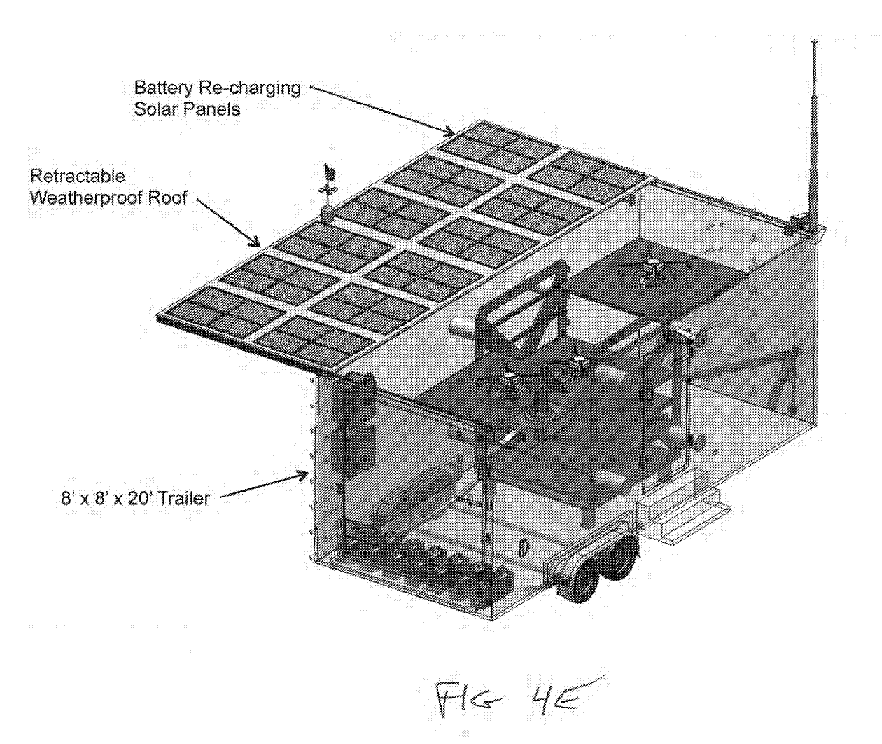

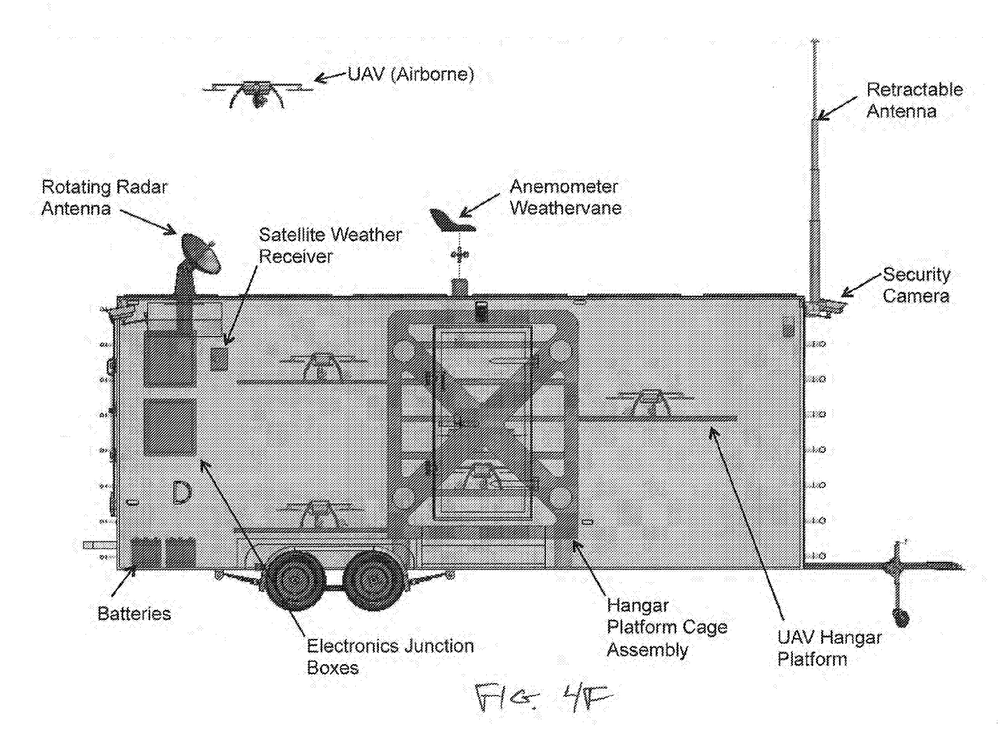

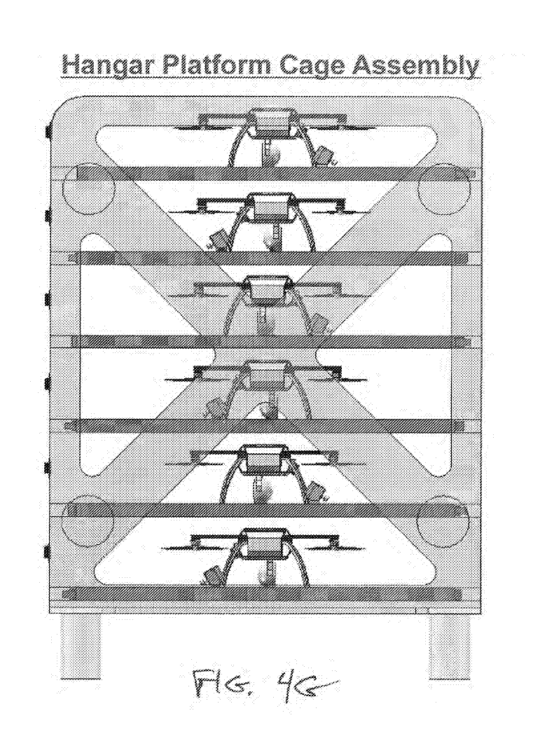

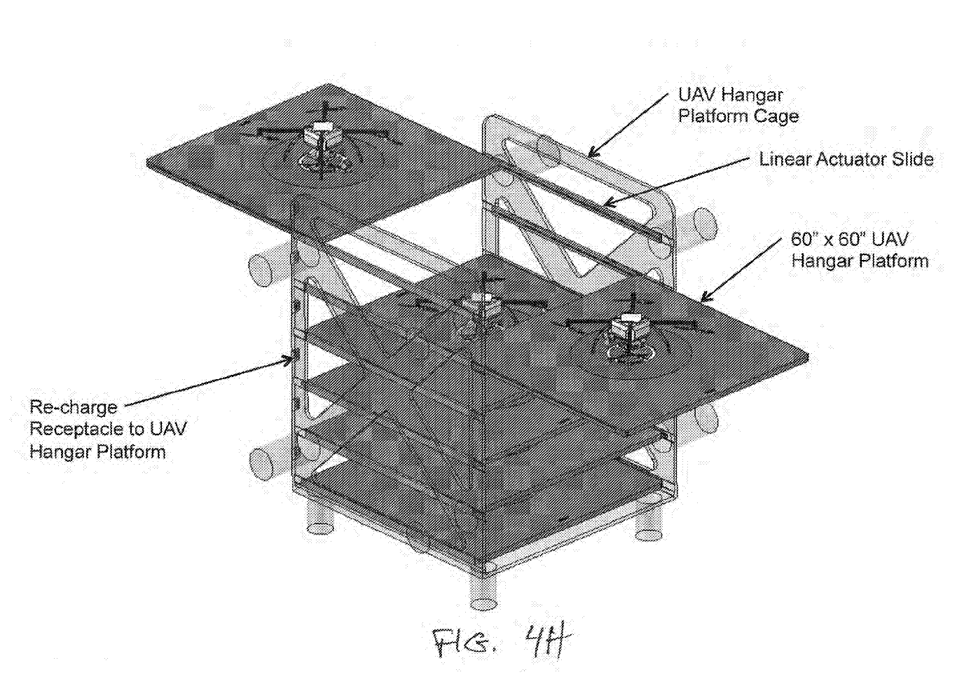

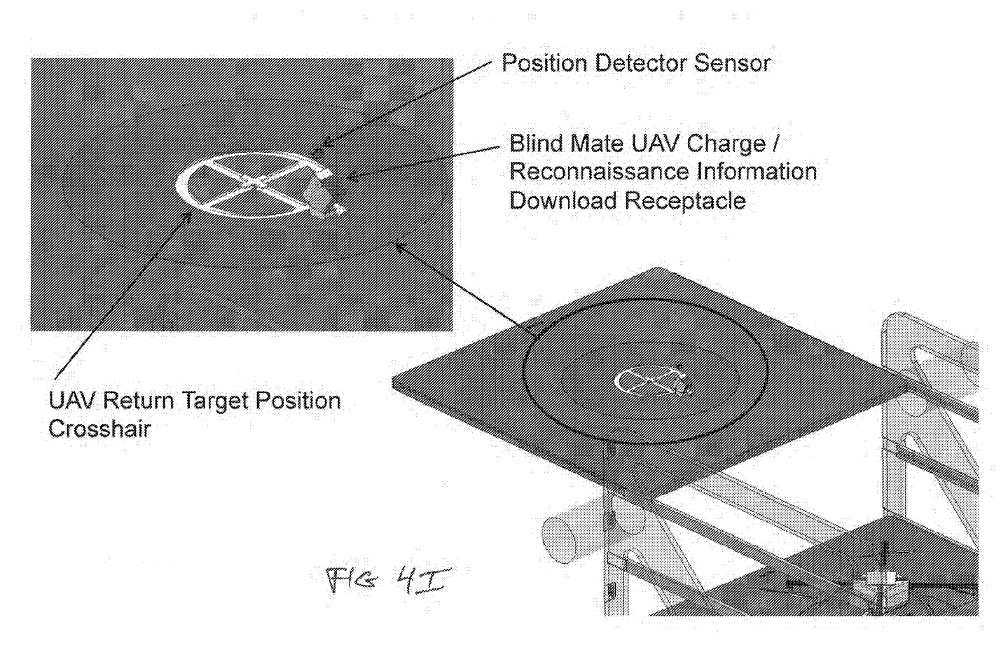

FIGS. 1A-1D show an exemplary embodiment of UAV system 100. In an embodiment, UAV system 100 can include a launcher or VTOL Hangar Cluster 102, hereinafter referred to as a VHC, comprising one or more containers, referred to herein as VTOL hangars (VH) 110 configured to house UAVs, e.g., VTOL UAV 118. In a nonlimiting embodiment, six hangars 110 can be mounted on a fixed support structure, such as tower 104, or can be mounted inside a mobile support structure, e.g., portable trailer 204 as shown in FIG. 2. FIGS. 2a-2F show a similar arrangement in a trailer-based system (FIGS. 4A-4I show alternative arrangements). FIG. 3 shows an exemplary UAV that could be used in the systems described herein.

Tower 104 containing UAV system 100 can be erected in an area to provide a security monitoring capability on a relatively long-term or even permanent basis, for example. Tower 104 can include security features, for example, a lockable hatch 106 to provide secure access to platform 108. In an embodiment, UAV system 100 can include accommodation for six VHs that can reside in the VHC. As shown in FIG. 1D, there can be six VHs arranged in a vertical stack that are stowed together in a VHC, similar to that of an automobile multi-CD changer system. The VHC can provide for each of the hangers to be positioned from the stowage to the launch position, wherein the launch position is the position that exposes the hangar to the open roof above to facilitate VTOL takeoff and landing. With the vertical stack of VHs, each VH can have a deck and four walls, but the top can be open in an exemplary embodiment. The tower or trailer can have a retractable “sun roof” type feature that can enable an opening to be made for VTOL takeoff/landing operations. Otherwise, the roof of the tower or trailer can be closed to prevent rain, snow, or dust from entering the system. The VHs can be made from known materials, such as composites, for example.

Tower 104 can be designed to resist tampering, for example, by shielding components with known armor materials, such as those used in bulletproof vests. Other suitable armor materials can be used to protect equipment from, for example, small-caliber handgun and shotgun projectiles and small fragments from explosives such as hand grenades. As mentioned, a secure, lockable platform 108 near the top of tower 104 can be provided for access to perform maintenance, for example. The platform 108 can be accessible via a ladder at the base of the tower through a secure, lockable hatch 106, for example. Additionally, the system can include local security monitoring features as part of a security subsystem. For example, motion sensors or other suitable detection devices placed on or near the UAV system can be monitored by the UAV system.

In an embodiment, in response to a motion sensor being triggered by a possible intruder, a camera system suitable for daytime and nighttime monitoring of the area around the UAV system can be automatically activated and can transmit live streaming video of the area around the UAV system. In addition to providing basic security, one or more cameras can be installed inside the system to specifically focus on the VH area to monitor the VTOL takeoff/landing actions. This video can be viewed from a remote location, for example. In an embodiment, a remote control station can also control functions, e.g., pan, tilt and zoom, of the UAV system's local security cameras.

In an embodiment, UAV system 100 can include a self-contained power generation and management system that can include an energy storage device, e.g., a battery bank, that can be kept charged by inputs from, for example, photovoltaic cells 112 and wind turbine 114 so that UAV system 100 can be self-sufficient and not require connection with an external power source. In an embodiment, connections can be provided to allow for power to be supplied from external sources, such as a portable electrical generator (not shown) or from an electrical utility grid.

In an embodiment, VHs 110 can include an enclosure 116 that can provide weather and small arms protection in the closed position. Outer door or retractable roof 117 can be configured to open before a deployment of a UAV 118, an example of which is shown in FIG. 3.

In an embodiment, UAV system 100 can include a UAV recovery feature. For example, the VHs 110 can facilitate the recovery of UAVs at the end of a flight. UAVs 118 can be vectored by known methods, e.g., GPS, to a latitude, longitude and altitude that can correspond to the center of VH 110 such that when the UAV arrives and hovers directly above a VH 110, it can then descend vertically into the VH 110, landing with some precision so that it can avoid touching the outer walls of the VH 110. When using a VTOL, such as the Aeryon SkyRanger, this unit can be 40″ square and can return to land to a position that it took off from with +/−2′ accuracy in the X/Y plane and +/−5 degrees of heading with respect to the VH, for example.

After landing and when the rotors have stopped, a VH 110 can then use mechanical arms, for example, that can position the UAV near a wall of the VH 110, facilitating the electrical connection of a blind mating electrical connector between the hangar and the UAV, which in turn can facilitate the UAV flight battery being recharged in the VH 110 without operator intervention. A typical VTOL that might be used in this application, such as the Aeryon SkyRanger, for example, can land precisely within the VH with +/−2′ accuracy in the X/Y plane and +/−5 degrees with regards to heading orientation to the VH. With that accuracy and the VH being sized large enough for it to safely land within the ceiling limits of the VH, the VH walls can have two mechanical arms that are activated to push the VTOL towards a wall of the VH with the electrical mating connector. A suitable connector for this purpose can be, for example, of a type such as a Positronic Scorpion connector. Once mated, the VTOL flight battery can be fully recharged in approximately 100 minutes, for example, to support another full flight of approximately 50 minutes. In addition to recharging, if the VTOL payload includes a camera, e.g., HD camera, that records to a memory stick on-board the VTOL that is not transmitted during flight via RF communications back to the launcher system, the electrical connector can also facilitate communications to the system to offload the HD video data to a storage system within the launcher/trailer such that it can be transmitted later to a remote location. Other suitable ways to facilitate the recovery of UAVs may also be used.

In an embodiment, UAV system 100 can include a command and control computer processor system that can perform a variety of controller functions, including power management, communications, launcher control, and system control, to name a few non-limiting examples. The command and control system can include known computer processors and other data processing and communications devices that are suitable for performing the above mentioned functions. In an embodiment, system power management can be performed by harnessing energy from the abovementioned environmental sources, e.g., electricity from solar panels or a wind turbine, to name some non-limiting examples, and automatically regulating power levels within a UAV system 100 energy storage system, e.g., a battery bank of suitable size, to perform UAV system 100 functions.

In an embodiment, launcher control functionality can be carried out by the command and control computer system using, for example, self-tests of individual VHs 110 with UAVs loaded to determine whether the UAVs and launchers/hangars are in a ready state before launch.

In an embodiment, a launch command signal can be provided by the command and control computer system to a VH. The command and control system can provide signals to the individual VHs and UAVs so that the charging connector is disconnected from the UAV before launch, the UAV is positioned in a VH 110 by mechanical arms or similar devices so that it is in the approximate center of a VH 110 for takeoff, the specific VH housing a VTOL for takeoff is positioned into the launch position (below the exposed roof), and then the VTOL UAV is commanded via RF to take off and conduct a flight. Once a UAV 118 takes off in flight, the VTOL UAV can be controlled remotely by a remote operator that can receive telemetry or other data, for example, about the UAV, as well as visual feedback from an onboard camera system. The control system can maintain an inventory of UAVs in the system and can provide an indication to an operator regarding VH and UAV inventory status and other desired system parameters.

In an embodiment, the command and control computer system can be wired from a computer, located on tower 104, for example, to individual VHs 110 within the VHC launcher 102. These wired signal paths can provide individual address capability from the command and control computer system to individual VHs with individual VTOLs within them.

In an embodiment, a wind vane and anemometer unit 126 can be used to provide wind speed and directional information to the command and control computer system. In an embodiment, a local connection to the UAV system can be provided for a laptop computer or any other suitable type of device, to be used by maintenance and operations personnel to check the health and status of the UAV system on site as well as control UAV launches locally. Such a local connection can be made using known wired or wireless methods.

In an embodiment, UAV system processors can also convert video received from UAV 118. For example, raw video in NTSC format can be converted to MPEG4 H.264 format for subsequent efficient bandwidth streaming to the Internet via a local cellular data connection of the UAV system. In an embodiment, a communications subsystem can be used to perform communications functions, such as system communications with the UAV 118 in fight as well as concurrent communications with a local commercial cellular network, for example, using known communications devices and methods. Communications with the UAV 118 can be performed while in the VH via an umbilical cable, for example, that can be connected to the UAV via a previously mentioned blind mating connector.

In an embodiment, once the UAVs 118 are in flight, the UAV system 100 can communicate with the UAVs 118 using a communications subsystem over multiple frequencies via a directional antenna 122 on the system tower 104, for example. In an embodiment, one frequency may be used for UAV command and control (i.e., used to instruct the UAV where to go), and another frequency may be used for the system to receive data from the UAV 118, for example, streaming video from camera(s) onboard the UAV 118. Communications with a local commercial cellular network, for example, may be accomplished using any suitable antenna 124.

FIGS. 2a-2F and 4A-4I show an illustrative embodiment of UAV system 200. UAV system 200 can contain the same or similar components as shown in FIG. 1 with UAV system 100, but can be arranged on a mobile support structure in a mobile or portable configuration such that system 200 can be transported on a trailer, for example, thus enabling a capability to be positioned at a location that is currently in need of monitoring but not necessarily on a long-term or permanent basis.

In such a portable configuration, a trailer and the UAV system components can be designed to fit into a standard ISO shipping container of approximately 8′×8′×20′ (2.4 m×2.4 m×12.2 m), for example, so that the system can be shipped and deployed as required. Once this mobile variant is unloaded near its deployment site, the trailer with UAV system components, which in one embodiment can weigh less than approximately 4000 lbs. (1814 kg), could be towed to an operational location by a suitable vehicle capable of moving such a load. In an embodiment, the trailer can be less than approximately 2000 lbs. (907 kg) and the UAV system 200 equipment on the trailer can be less than approximately 2000 lbs. (907 kg), resulting in a total system weight of approximately 4000 lbs. (1814 kg).

In an embodiment, UAV system 200 can include a telescopic type arrangement to facilitate raising and lowering the communications antennae on a tower. Other suitable methods and structures may also be used to raise and lower system 200 components. A non-limiting example of a suitable trailer is a dual-axle trailer with a standard 2″ (5 cm) receiver hitch for towing by known vehicles with suitable towing capacity. As with system 100 shown in FIG. 1, the local components of system 200 may not all be located on a tower.

For both the fixed/permanent tower-based and portable variants of the UAV system, the following descriptions can apply, but reference will be made to the embodiment shown in FIG. 1. In an embodiment, an electrical connection between VH 110 and other UAV system 100 components can be designed such that operators and maintenance personnel can communicate with a UAV in the VHs.

In an embodiment, once a UAV has been launched and recovered, the UAV can be recharged and flown again after charging the main flight battery with minimal to no human intervention. Having six VHs 110 and associated UAVs that can each fly for approximately 1 hour and then require approximately two hours to recharge, the system can have UAVs out on station performing reconnaissance, for example, several miles from the launcher on a continual basis. The UAV, and other UAV system components can be selected to survive expected UAV flights in an expected UAV flight environment and be reusable for subsequent reuse. UAV batteries will eventually need to be recharged.

FIG. 2F shows an illustrative embodiment of a close-up view of internal components of the VH subsystem. In an embodiment, a blind mating connector, e.g., an umbilical-type connector can be mechanically connected to the UAV in the VH such that the UAV can communicate via the VH and command and control system with a local or remote control station. The blind-mating connector can be designed to not interfere with the launch process as it can be located in a position near the extremity of the VH and not near the center reserved for takeoff/landing actions, for example. With the UAV connected to the VH with this blind-mating connector, it enables the UAV to be preset and monitored before launch, in addition to keeping the UAV battery in an optimally-charged state for maximum flight time. In an illustrative embodiment, blind-mating connector can be made with 14 connector pins. The connector can be pulled out of a UAV-side connector when the UAV begins its repositioning to the center of the VH to facilitate takeoff to flight out of the VH. In an embodiment, after being connected to the UAV, a blind-mating connector can be positioned in an area off to the side of the VH. In an embodiment, the blind-mating connector can be positioned so that it will not interfere with the travel of a UAV from the stowed to the launch/land position in the center, for example, of the VH.

In an embodiment, as an alternative to a blind-mating electrical connector described above, an internal UAV motor battery can be kept charged using known wireless induction methods by positioning the UAV within effective range of an induction transfer unit within the VH. In an embodiment, information such as stored HD video can be exchanged between the command and control system and the UAV in a VH via a wireless infrared, Bluetooth, or other known wireless linkage.

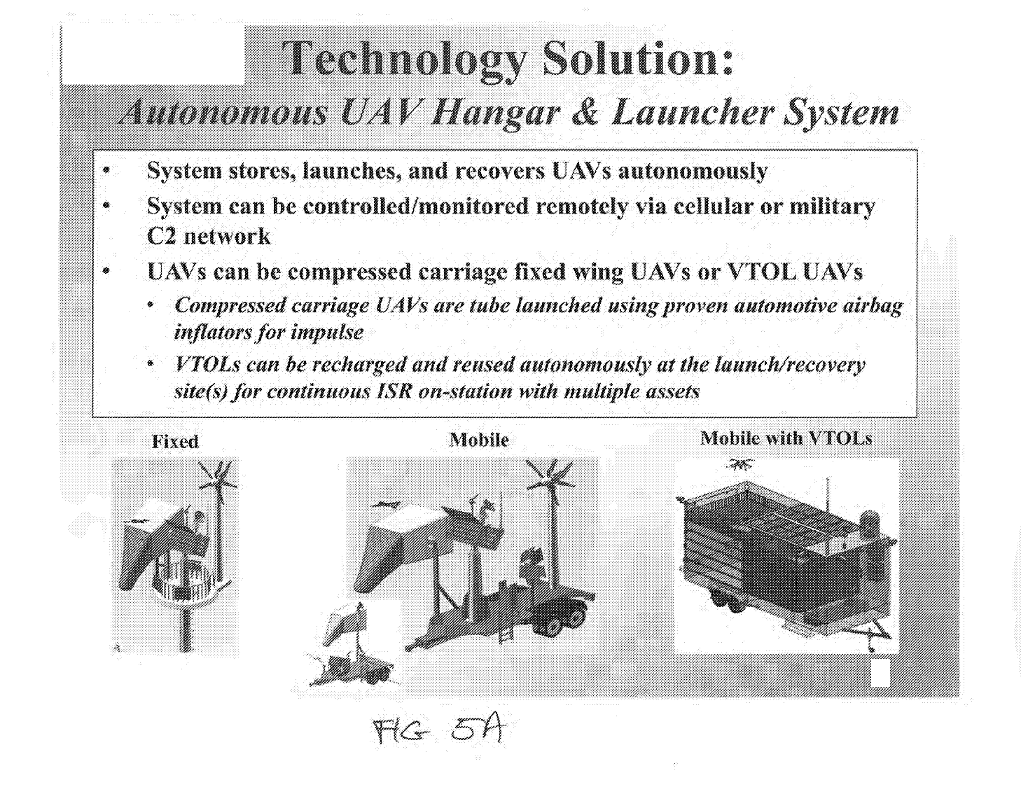

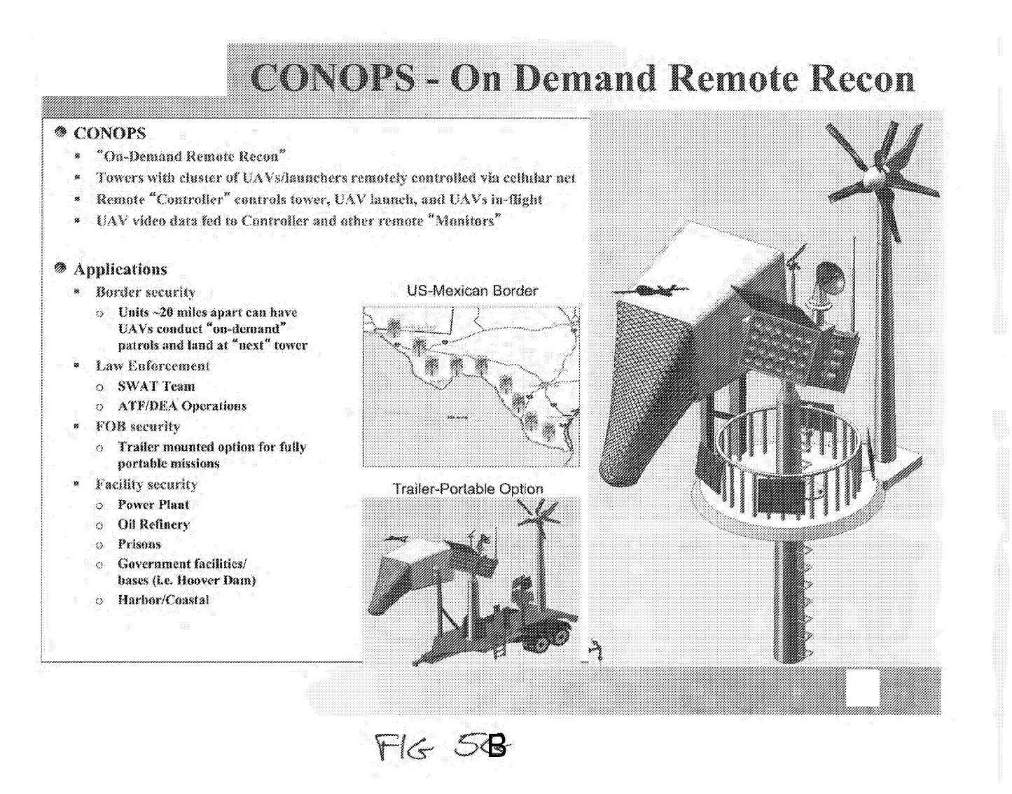

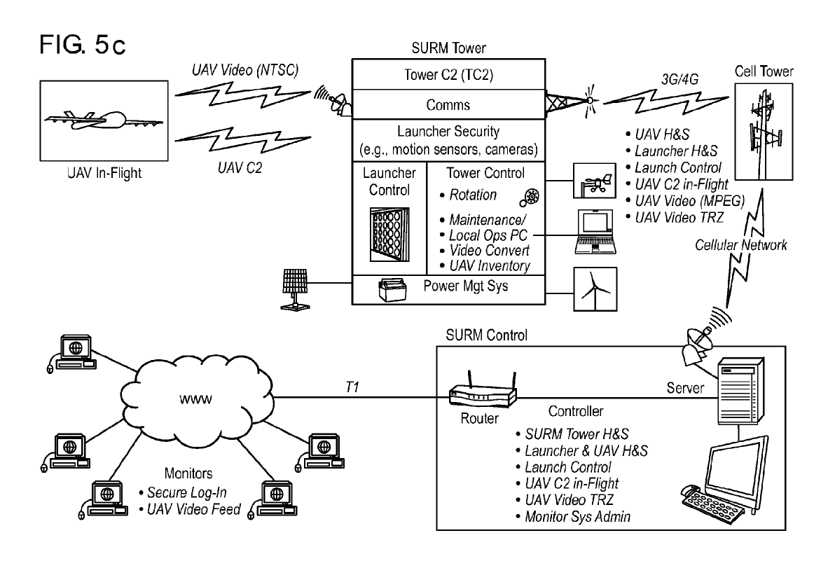

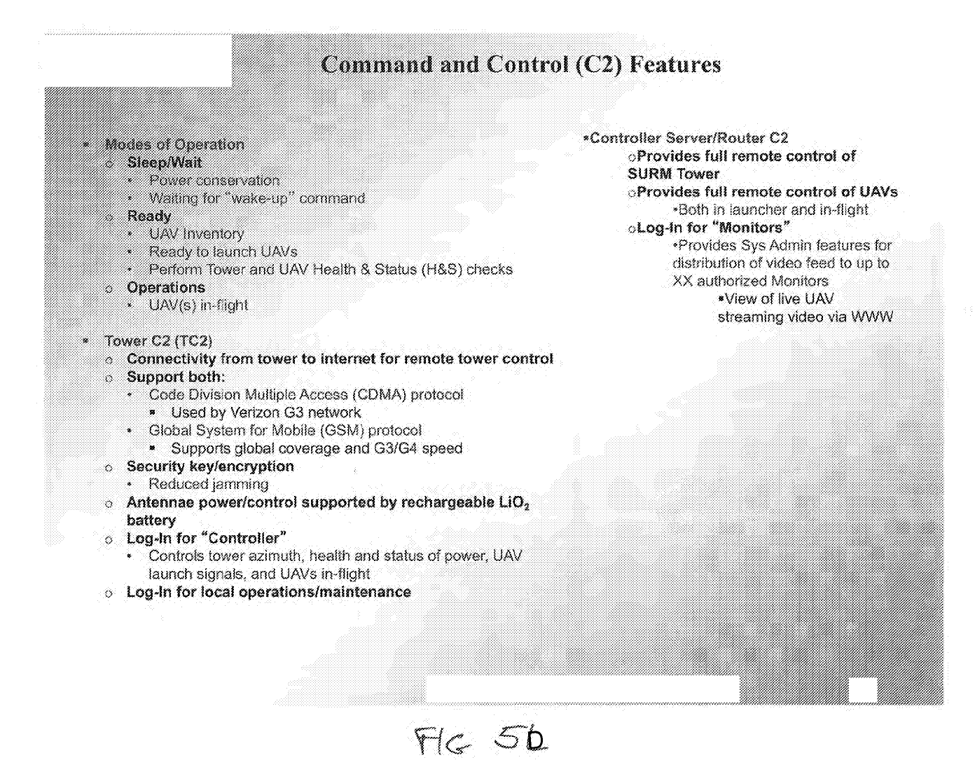

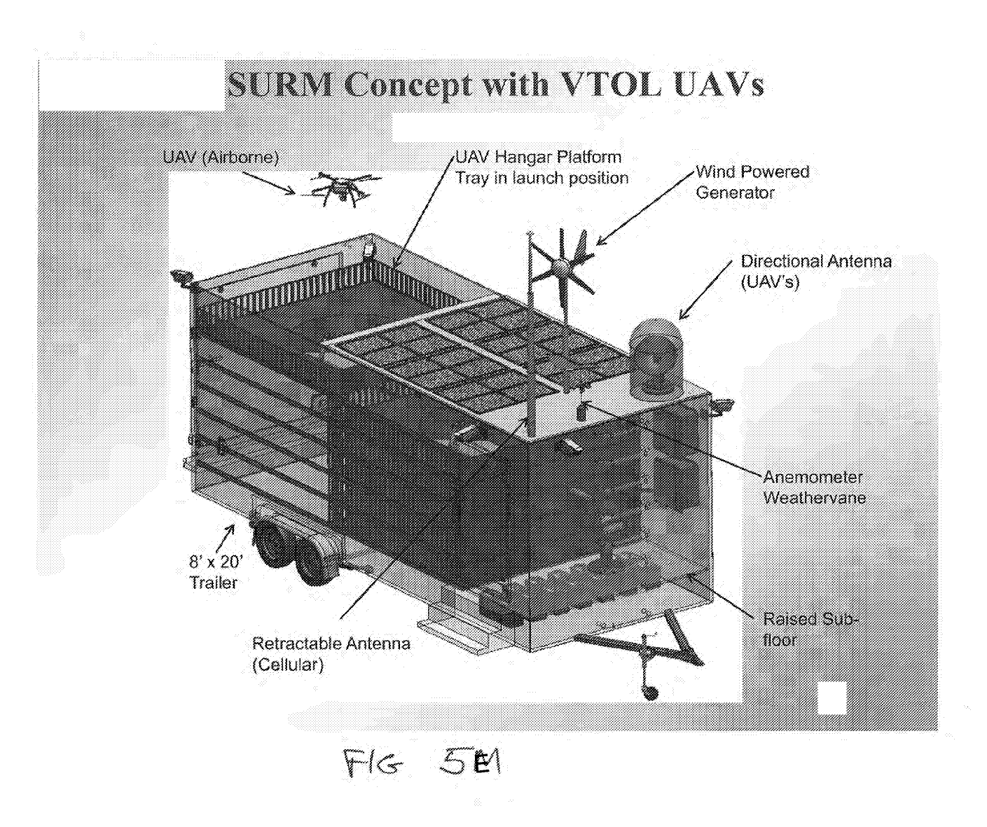

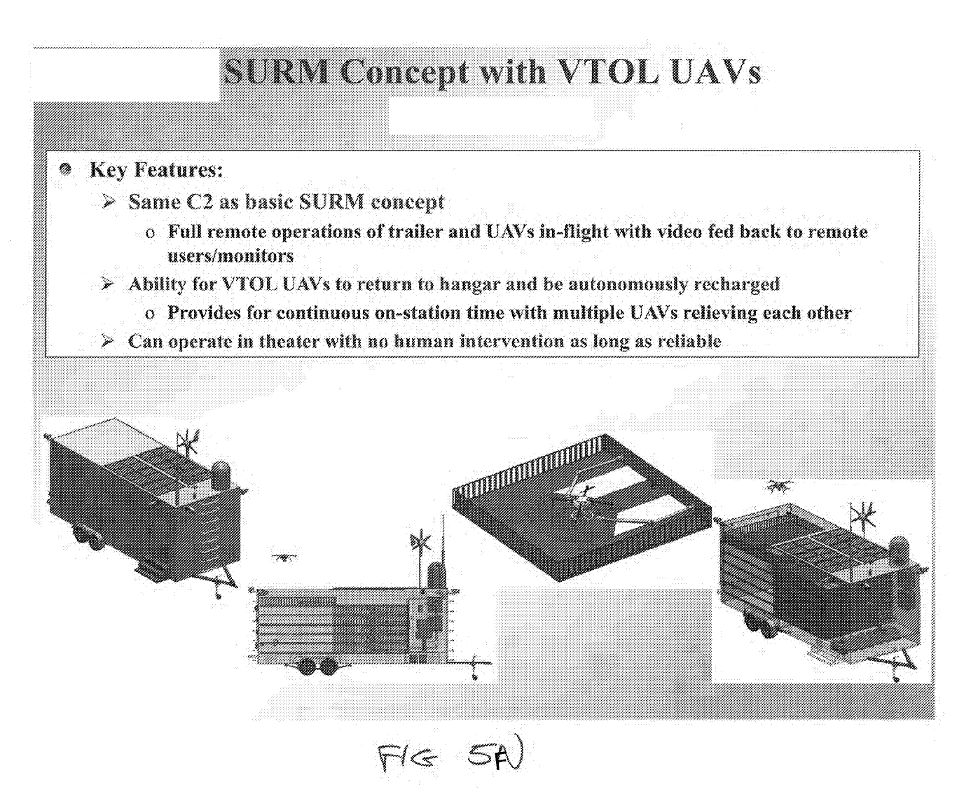

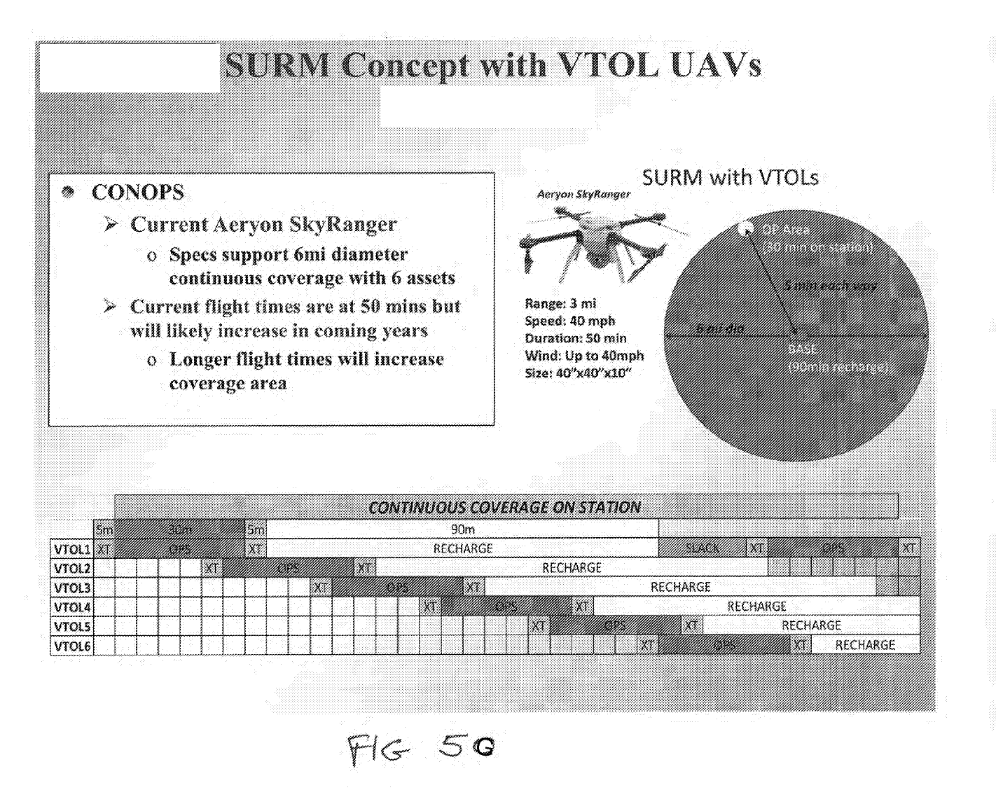

FIG. 5K shows a block diagram of an illustrative embodiment of a UAV system command, control and communications system architecture that can be implemented using UAV system 100's control and communications subsystem. In this illustrative embodiment, the UAV system is referred to as “SURM,” for Security UAV Reconnaissance Module. In an embodiment, connectivity of the UAV system to the Internet via a cellular network, for example, can enable the UAV system to be accessed by a remote control station. The remote control station can control the UAV system as well as administer the ability of other remote users to access a remote control server, for example, to be able to monitor UAV data, such as video, in a secure manner. In an embodiment, the remote control station can control the launch, flight control, and landing/homing of UAVs, whereas other users may only have the ability to monitor data from the UAV via the Internet.

In an embodiment, connectivity between the UAV system and a remote control station may be achieved by using known 4G or LTE cellular networks and protocols, for example, Code Division Multiple Access (CDMA) or Global System for Mobile (GSM), in order to provide UAV system capability worldwide. In an embodiment, in areas where cellular service may not be available, or in an environment such as a military application where reliance on commercial cellular networks may not be desirable, other alternative command, control and communications schemes can be employed. In an embodiment, satellite communications can be employed such that the UAV system can communicate directly via a satellite link to a remote control station or via the Internet after satellite linkage.

In an embodiment, an airborne asset, such as an AWACS, can be employed as a primary command, control and communications node with a remote control station inside the airborne asset. In an embodiment, an airborne asset could relay the UAV system command, control and communications signals to a remote operator at another location, such as on a nearby ship or shore facility. In an embodiment, there can be two operators remotely controlling UAV functions. For example, one operator can control and monitor the UAV command and control functions while a second operator can be dedicated to controlling and monitoring the functions associated with a UAV's payload, for example, a camera or other sensor, or a munitions payload.

In an embodiment, a remote control station can control UAV launch, but after the UAV is airborne and over an area of interest, a local operator on the ground can assume control of the UAV such that the local operator takes control of the UAV and payload, e.g., camera, and landing aspects of the UAV in a more local type of operation.

In an embodiment, the UAV system can be configured to be pre-programmed via a remote control station to launch a UAV at a desired time in the future to, for example, make a patrol video scanning run down a security line of interest. In an embodiment, the UAV can return to the UAV system from which it was launched or proceed to another one. In this example, the video from this type of run can be stored on a server and be available to a remote control station operator or fed to other monitors to be viewed at a later time. In an embodiment, such a capability can allow the programming of patrols by UAVs to record video in areas of interest at specific times of interest while minimizing the need for human interaction with the system.

In an embodiment, a UAV system can be associated with other remote sensors, e.g., motion sensors, and configured to automatically launch a UAV to a nearby area, e.g., within approximately 5-15 miles, in response to a signal from the other, e. g., motion sensor. This capability can allow for the rapid, automatic surveillance of an area, e.g., within several minutes, as compared with systems requiring control by operators.

In an embodiment, the UAV system can function in three basic modes, e.g., SLEEP, READY, and OPERATIONS. In SLEEP mode, the UAV system can conserve battery power while waiting to receive a “wake-up” command from a remote control station, for example. In an embodiment, while in the SLEEP mode, the system can still perform some active functions, such as local security monitoring using a security subsystem. For example, motion sensors or other suitable detection devices placed on or near the UAV system can be monitored by the UAV system. In an embodiment, when a motion sensor is triggered by a possible intruder, for example, a camera system suitable for daytime and nighttime monitoring of the area around the UAV system can be automatically activated and can transmit live streaming video of the area around the UAV system that can be viewed from a remote location.

In an embodiment, a remote control station can also control functions, e.g., pan, tilt and zoom, of the UAV system's local security cameras. Upon receipt of a “wake-up” command, the UAV system can perform, for example: self-tests, checks of the inventory and status of loaded UAVs, and reporting to a control station that the UAV system is ready for launch. Such a system readiness signal could allow the UAV system to transition to the READY mode.

In an embodiment, the UAV system can remain in the READY mode for up to one hour, for example, before returning to the SLEEP mode if no launch has been initiated. If a UAV is launched during READY mode, the UAV system can enter OPERATIONS mode. Upon receiving the launch signal from the command and control subsystem, the VTOL UAV in the top hangar exposed and ready for flight could be disconnected from its umbilical cable to the VH it resides in. The retractable roof, or “sun roof,” of the tower/trailer could be retracted exposing the top VH to the open air vertically, and then the VTOL could perform its own pre-flight checks and then take off vertically and hover above the tower/trailer. In the OPERATIONS mode, the UAV system can serve as a communication node between remote stations and the UAV in flight. Upon achieving successful hover condition, the remote human operator can then take control of the UAV to direct it to a way point of interest at a specified speed and altitude. While in flight, the UAV system can receive streaming video from the UAV and can send command and control instructions to the UAV to fly specific tracks based on control station direction. When the mission is completed or battery life is estimated to be low to the point where the VTOL UAV has just enough power to return to the launcher (based on known time/distance from the launch point), the VTOL can provide an alert to the remote operator that it is proceeding back to the launcher and can do so autonomously. Upon arriving at the launcher, the system can have rotated the carousel, for example, depending on hangar configuration, such that an empty hangar can be positioned at the top, ready to receive the returning VTOL UAV. The VTOL UAV can autonomously approach and land precisely in the center of the open VH with enough+/−tolerance accuracy such that it need not strike the walls of the VH and land safely within its walls before shutting down the rotors.

In an embodiment, exemplary setup, operations and shutdown sequences can be described as:

SETUP to READY/SLEEP modes

Operator tows trailer to area of interest and parks trailer. Alternatively, a UAV system could be transported by airborne or waterborne vessels.

Operator powers up trailer and ensures all antennae and power systems are up and running.

Remote controller links up with trailer and confirms he has control of trailer/launchers/UAVs/etc.

Operator leaves trailer in READY state unattended.

After 30 minutes, for example, of being in the READY state, the trailer transitions to SLEEP mode, keeping its batteries charged and waiting for a remote command to wake up to OPERATIONS mode

OPERATIONS (The following steps can be performed autonomously through pre-programmed sequences, by a remote operator/controller, or by a combination thereof.)

Indication is received that Intelligence Surveillance and Reconnaissance (ISR) services are required in the area of interest (within approximately, e.g., 6 miles of the trailer). This could be in the form of intelligence from any source, or a perimeter sensor (e.g., motion sensor) that indicates there is activity of interest within the area.

System does inventory and determines which VH and VTOL are sufficiently charged and ready for operations (by way of example, VTOL1 in VH1 is selected).

VH1 is moved from stowed position (e.g., forward of trailer) to deploy/retrieve position (e.g., aft of trailer under retractable roof).

VTOL1 in VH1 tray is positioned within VH away from blind-mating connector, for example, into center of VH by mechanical arms or other suitable positioning device or technique.

Roof door is retracted exposing VH1 (top unit), door open sensor is activated telling system door is fully open and clear for VTOL takeoff.

VTOL1 establishes communications via RF, for example, with command and control system in trailer, for example, for autonomous vertical takeoff and ascends out of trailer to a nominal height above trailer, such as 40′.

After VTOL1 has cleared the trailer, and if the remote controller wants continuous ISR beyond 30 minutes (nominal), VH1 and VH2 can be positioned such that VH1 is back in stow position and VH2 is moved to deploy/retrieve position.

VTOL1 achieves a desired altitude and then a remote controller can take C2 of VTOL directing it to a waypoint (e.g., GPS latitude/longitude) via cruise altitude. Alternatively, the remote controller can manually stick-fly the VTOL live with constant course/speed/heading adjustments as it flies towards the op area.

When VTOL1 gets to the area of interest, the remote controller can hover the VTOL for a persistent look or “stare” at a target of interest, providing video back to the operator(s). Alternatively, the VTOL1 can be directed to maneuver anywhere within range to various altitudes and bearings from the target of interest, all the while providing video back via the trailer, for example, to the remote controller and monitors. Alternatively, the VTOL1 can be assigned a prescribed track/course to follow while recording video surveillance for future review.

When VTOL1 battery life indicates it has reached a point where it has just enough life to return to the trailer, plus some buffer(=spare time plus time for next VTOL to relieve on station), if desired, the trailer can repeat the above process to prepare and deploy VTOL2 to relieve VTOL1 on-station.

When VTOL2 arrives on station, VTOL1 can be commanded to return back to the trailer or to another location, and while they are relieving, the VH can shuffle, e.g., move to suitable launch, recovery, or storage positions, making VH1 ready to receive VTOL1.

When VTOL1 returns to the trailer, it can hover precisely over the VH deploy/retrieve position at 40′ altitude, for example, and stabilize.

Upon stabilization, VTOL1 can descend back into the center of VH1, for example, and touchdown as close as possible to the center position, or other desired position, with a correct heading, such as the one it departed on. The approach and landing can be done autonomously or by a remote operator/controller. In an exemplary embodiment, a video camera used for surveillance on the VTOL UAV itself can be used for controlling the approach and landing. For example, on each vertical hangar tray there could be a target, either painted or adhered to the floor. The UAV's camera could be pointed directly downward and in the forward orientation and used in conjunction with the GPS to bring the UAV over the landing point. The GPS could be used to get the UAV in video range of the target and then the video camera and software could use object recognition to align the target with a known image to guide and hold the UAV over the landing zone.

VTOL1 can then be retracted within VH1 by mechanical arms or other suitable devices or methods with the blind-mating connector to be recharged and offload any HD video.

This process above can be repeated with VTOL2 being relieved by VTOL3, etc., until VTOL1 relieves VTOL6 and then continuous operations can proceed almost indefinitely.

SHUTDOWN/SLEEP

After some predetermined time when all VTOLS have returned to VH and no operations are in progress, a wait time of 30 minutes, for example, can elapse in READY mode.

After this time period has elapsed, the system can return to SLEEP mode, preserving power and keeping the system and VTOLs in a fully charged state

Power management can be performed by the system automatically harnessing solar and/or wind power to keep systems in an optimally charged state.

In an embodiment, an example of a suitable UAV is an Aeryon Skyranger that can cruise at 40 mph with duration of 50 minutes and a range of just over three miles. With recharging time estimated at 100 minutes for these UAVs, having a quantity of six UAVs in a VH arrangement in one system could provide the ability for UAVs to maintain continuous and indefinite surveillance at a 3-mile radius distance from the deployment site. FIG. 5G shows an example of this embodiment.

In an embodiment, the UAV system can employ security features, such as encrypted communications that can minimize tampering, jamming or interference with the communications frequencies to and from UAVs in flight as well as to the cellular network, for example. The UAV system can be configured with specific USER ID account information only available to the control station, for example, for access, e.g. login to the system, and control of the UAV system.

In an embodiment, the UAV system can have a directional antenna for communicating with UAVs to maximize signal strength and resulting communication ranges between launched UAVs and the UAV system. In an embodiment, antenna rotation and azimuth control power can be provided by a rechargeable battery, for example, a LiO₂ battery.

In an embodiment, UAVs can communicate with the UAV system on configurable frequencies, for example 900 MHZ, 1.7 GHZ, or 2.4 GHZ for command and control signals that can be used to control UAV course, speed, altitude, waypoints, battery life, and general health and status, for example.

In an embodiment, UAVs can provide streaming video to the UAV system on 2.4 GHZ or 4.8 GHZ, for example. The system can be capable of communicating with two or more UAVs in flight simultaneously so one can “relieve” another on station in an operating area (OPAREA). This can facilitate communications with UAVs while in transit and/or on station.

In an embodiment, in situations where poor signal quality or jamming conditions can exist, alternative methods of transmitting on various frequencies, including automatically switching among frequency channels, can be employed at the UAV, at the UAV system and at a remote station.

In an embodiment, UAVs can be launched from one UAV system and can be recovered at another UAV system for example. Thus, UAVs do not necessarily have to return to the system from which they were launched. This can facilitate, for example, a “patrol” option, wherein a UAV can patrol an area of interest from one point to another. In an embodiment, a distance between UAV systems may be based on the communications range of the systems employed and may not necessarily be the limit of the distance a UAV can fly.

In an embodiment, in the event a portable variant of the UAV system is in motion or a UAV system is moved after a UAV is launched, the UAV system can still provide command and control of a UAV in flight and a UAV can still find its way back to the UAV system, even though the launch point may have moved. For example, a fixed “lever arm,” which can be described as the 3D vector description of the precise distance from a GPS location on the UAV system to the precise center of the VH, can be used by the UAV during its return flight home to find the center of the VH no matter where a tower, for example, is located.

In an embodiment, the UAV system can be integrated with land-based vehicles or waterborne vessels. In these examples, power supply and management can be provided by the host platform. Other aspects of the UAV system can still be as described above, however, remote operation may be performed while embarked on the vehicle or vessel. If the host vehicle or vessel is itself operated unmanned, remote operation of the UAV system can be configured as previously described.

In an embodiment, UAV battery life can be monitored, for example, continuously, both in the VH and while in flight. An alert can be provided to a remote operator when UAV battery life is at a point of having just enough power to return to the nearest UAV system for recovery, for example.

In an embodiment, a remote control station can be provided with the ability to acknowledge a low battery alert. In an embodiment, instead of directing the UAV to fly “home,” e. g., to the nearest UAV system, the UAV could instead be kept on station, providing additional surveillance video, for example, with the realization that the UAV will land elsewhere and not at a UAV system. In an illustrative scenario, a ground-based individual could retrieve a UAV from where it lands away from a UAV system, replace the battery in the UAV and launch the UAV locally to provide a rapid turnaround of surveillance capability.

Exemplary UAV payloads can include still and video cameras suitable for daytime or nighttime operations. In an embodiment, video transmitted by the UAV can be analog NTSC at 480 lines or higher definition video. In an embodiment, a UAV can be equipped with a suitable IR camera with 320×240 resolution with white or black hot display, for example. In an embodiment, a UAV can be equipped with a high-resolution electro-optical camera at 5 megapixel resolution, for example. The quality of the video and photos from UAV cameras can be enhanced by known video enhancement firmware onboard the UAV or by software at a control station, for example. UAV payloads can also be selected to provide other capabilities, such as through the use of suitable biological, radiological and chemical sensors, to name a few non-limiting examples.

In an embodiment, a UAV can be equipped with a munitions payload, for example, to permit the UAV to perform strike operations in addition to monitoring and surveillance. For example, a UAV with a munitions payload can be directed to fly to an area of interest and conduct video surveillance of a detected target. In an embodiment, a control station operator can direct the UAV to the target and fly an impact route into the target. The UAV's munitions payload can be detonated by impact or proximity sensors or by remote command, for example, in an effort to eliminate or disable the target.

These aforementioned aspects of various embodiments of the UAV system can allow UAVs to be pre-positioned by either a relatively permanent or portable UAV system variant at locations where occasional or frequent surveillance may be desired. The concepts presented herein, e.g., using quadcopters or similar VTOL or hybrid UAVs, can be made into a hybrid system along with impulse launched compressed carriage UAVs by which a new hybrid system could contain a mixture of quadcopter UAVs focused on surveillance-type operations, and some compressed carriage fixed-wing UAVs that are launched out of tubes can be focused on munitions payload delivery operations. This can be desirable since the cruising speed of compressed carriage UAVs can be much higher, while the quadcopters can provide the ability for “persistent stare” while hovering near a target of interest.

By reducing the need for personnel to deploy to areas to launch, operate, and recover UAVs, the cost of security operations can be reduced by allowing many aspects of UAV system operation to be conducted remotely. In addition, the time required to deploy a UAV to a remote site can be greatly reduced if the UAV system can be pre-positioned in relatively close proximity to the area of interest, for example, less than approximately 5 miles (8 km).

In various embodiments, the UAV system can be used in applications such as border security, law enforcement, military Forward Operating Base (FOB) security, or general security for high-value facilities such as power plants, oil refineries, prisons, government facilities/bases, or coastal security/defense, to name a few non-limiting examples.

The above description is presented to enable a person skilled in the art to make and use the systems and methods described herein, and is provided in the context of a particular application and its requirements. Various modifications to the embodiments will be readily apparent to those skilled in the art, and generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. An unmanned aerial vehicle (UAV) system, comprising:
a launcher, comprising:
one or more containers, each container configured to house one or more UAVs, each container comprising an orientation and charging module configured to mechanically position the UAV within the hangar and facilitate electrical mating and charging of a battery in the UAV;
and
a power generation and storage subsystem comprising at least one of a photovoltaic cell, a portable generator, and a wind turbine for supplying power to the UAV system.

2. The UAV system of claim 1, wherein the UAV is a VTOL UAV.

3. The UAV system of claim 1, wherein the UAV is a multi-rotor helicopter.

4. The UAV system of claim 3, wherein the multi-rotor helicopter is a quad-rotor helicopter.

5. The UAV system of claim 1, wherein the UAV is a hybrid VTOL/fixed-wing UAV.

6. The UAV system of claim 1, further comprising a security subsystem configured to permit remote monitoring an area around the UAV system.

7. The UAV system of claim 1, wherein the launcher is mounted on a fixed support structure.

8. The UAV system of claim 1, wherein the launcher is mounted on a mobile support structure.

9. The UAV system of claim 1, wherein the launcher is mounted on a waterborne vessel.

10. The UAV system of claim 1, further comprising a command and control subsystem and a communications subsystem configured to allow manual UAV launch by a remote operator.

11. The UAV system of claim 1, further comprising a command and control subsystem and a communications subsystem configured to allow automatic UAV launch in response to a signal from a remote sensor.

12. A method of operating an unmanned aerial vehicle (UAV) system, comprising:
choosing a suitable UAV in a suitable container based on preselected readiness criteria of the UAV and container;
positioning the UAV below a retractable roof;
retracting the retractable roof; and
launching the UAV in a generally vertical direction.

13. The method of claim 12, further comprising:
positioning the suitable container from a stowed position to a deploy/retrieve position.

14. The method of claim 12, further comprising:
positioning the UAV such that it is disconnected from a mating connector.

15. The method of claim 12, wherein preselected readiness criteria of the UAV and container includes at least one of charge state of a UAV battery and location of the container.

16. A method of operating an unmanned aerial vehicle (UAV) system, comprising:
retracting a retractable roof over a container;
hovering a UAV over the container using at least one of a GPS navigation system and a video camera; and
recovering the UAV into the container.

17. The method of claim 16, further comprising:
positioning the UAV such that it is connected to a mating connector.

18. The method of claim 16, further comprising:
positioning the container from a deploy/retrieve position to a stowed position.
